(19) United States
(12) Patent Application Publication
(10) Pub. No.: US 2017/0061705 A1
(43) Pub. Date: Mar. 2, 2017

(54) PARKING METER PAYMENT SYSTEM

(71) Applicant: AGUSTIN ULLOA, PASSAIC, NJ (US)

(72) Inventor: AGUSTIN ULLOA, PASSAIC, NJ (US)

(21) Appl. No.: 14/834,998

(22) Filed: Aug. 25, 2015

(51) Int. Cl. G07B 15/02; H04W 4/00; H04W 4/12

(52) U.S. Cl. CPC G07B 15/02; H04W 4/12; H04W 4/008

(57) ABSTRACT

The parking meter payment system is a device adapted to interface with a parking meter that automates the payment of parking fees. The parking meter payment system comprises a transponder, a meter module, and a smart phone application. The transponder is an electronic device that is placed in an automobile. When the automobile is parked within range of a parking meter, the parking meter interrogates the automobile using radio frequency identification technology. If the parked automobile is equipped with the transponder, the transponder responds to the radio frequency identification interrogation with an identification code. Upon receiving the identification code, the parking meter connects to a validation server to validate the identification code. Once the identification code is validated, the parking meter transmits a second interrogation which activates a circuit within the transponder that lights a display LED indicating that the automobile is parked legally.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of electrical devices with provision for identification, more specifically, a radio frequency identification device adapted for use with parking meters.

### SUMMARY OF INVENTION

The parking meter payment system is a device adapted to interface with a parking meter that automates the payment of parking fees. The parking meter payment system comprises a transponder, a meter module, a smart phone application. The transponder is an electronic device that is placed in an automobile. The meter module is an electronic device that is placed within the parking meter. When the automobile is parked within range of a parking meter, the meter module transmits a first interrogation to the automobile using radio frequency identification technology. If the parked automobile is equipped with the transponder, the transponder responds to the radio frequency identification first interrogation with an identification code. Upon receiving the identification code, the meter module connects to a validation server to validate the identification code. Once the identification code is validated, the meter module transmits a second interrogation, which activates a circuit within the transponder that lights a display LED indicating that the automobile is parked legally.

The meter module continually transmits the first interrogation to confirm that the automobile is still parked in its location. If the meter module determines that the automobile is still parked, it transmits the second interrogation refreshing the circuit within the transponder so that it maintains the valid parking indication. If the meter module fails to receive the interrogation response, the meter module contacts the validation server and transmits an invoice for the parking services rendered.

Upon receiving the request for validation, the validation server transmits a message to the smart phone application indicating that parking charges are being incurred. Upon receipt of the invoice, the validation server again transmits a message to the smart phone application indicating that parking services have been discontinued and that an invoice has been received.

Optionally, a time display can be incorporated into the transponder. Intermediate messages regarding parking time remaining in limited time parking spaces can be transmitted via the smart phone application.

These together with additional objects, features and advantages of the parking meter payment system will be readily apparent to those of ordinary skill in the art upon reading the following detailed description of the presently preferred, but nonetheless illustrative, embodiments when taken in conjunction with the accompanying drawings.

In this respect, before explaining the current embodiments of the parking meter payment system in detail, it is to be understood that the parking meter payment system is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the parking meter payment system.

It is therefore important that the claims be regarded as including such equivalent construction insofar as they do not depart from the spirit and scope of the parking meter payment system. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a perspective view of an embodiment of the disclosure.

FIG. 2 is a front view of an embodiment of the disclosure.

FIG. 3 is a rear view of an embodiment of the disclosure.

FIG. 4 is an in-use view of an embodiment of the disclosure.

FIG. 5 is a block diagram of an embodiment of the disclosure.

FIG. 6 is detail view of an embodiment of the disclosure.

FIG. 7 is a block diagram of a detail of an embodiment of the disclosure.

FIG. 8 is a flowchart for an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

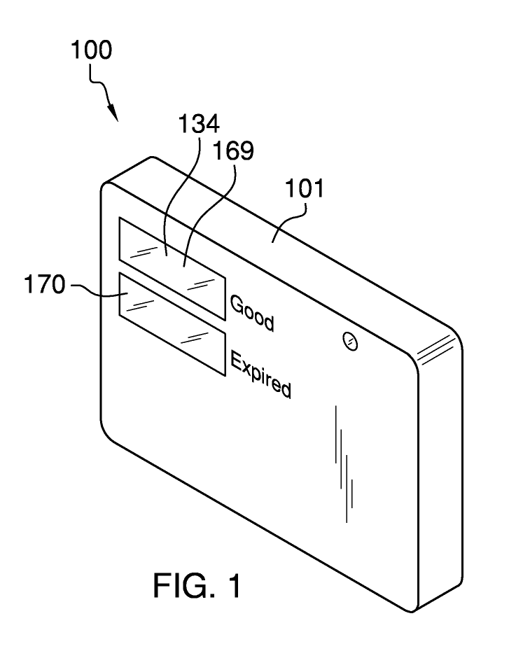

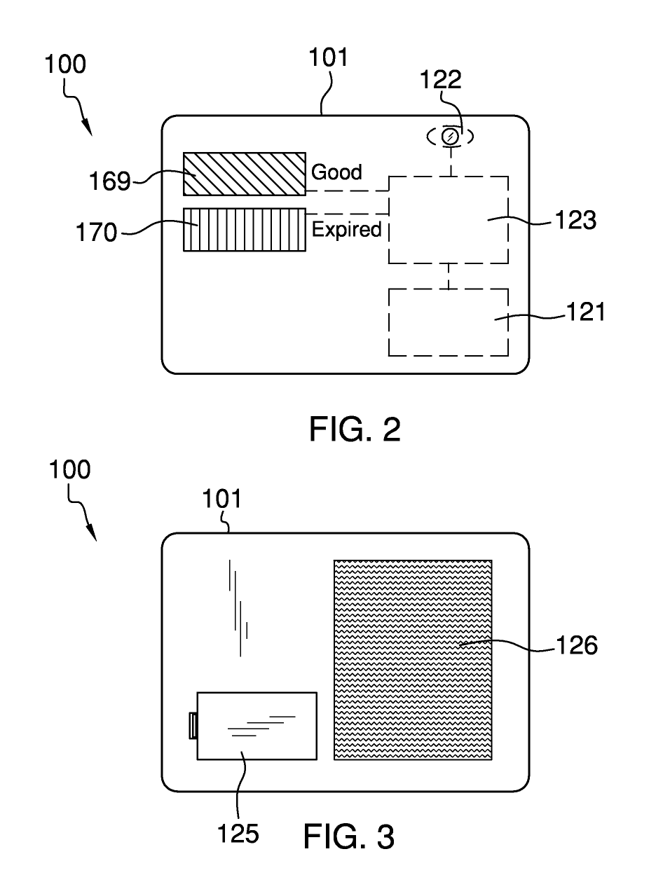

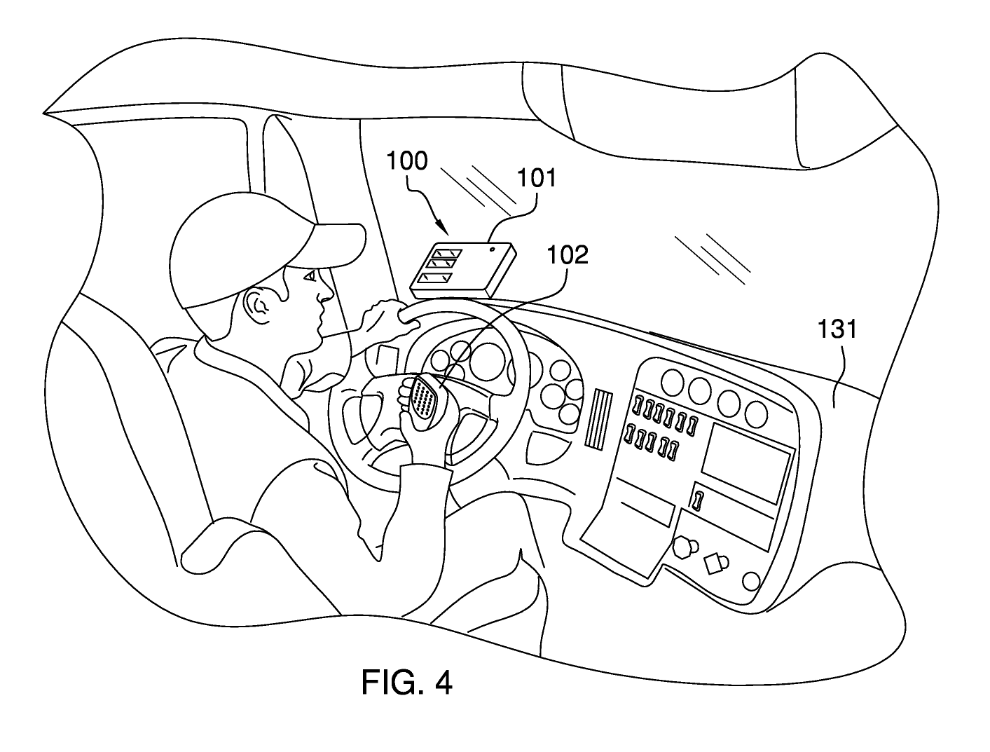

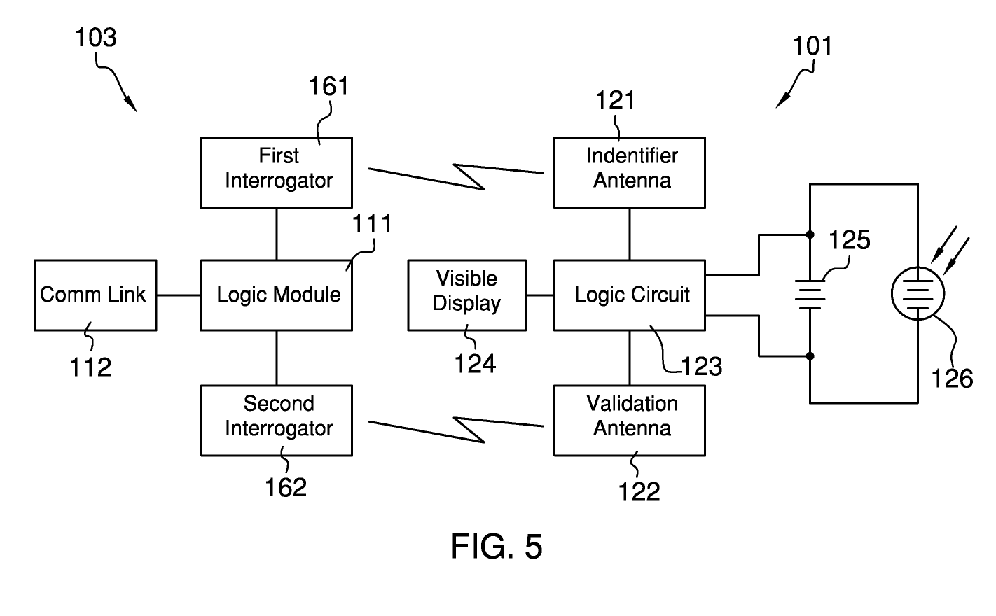

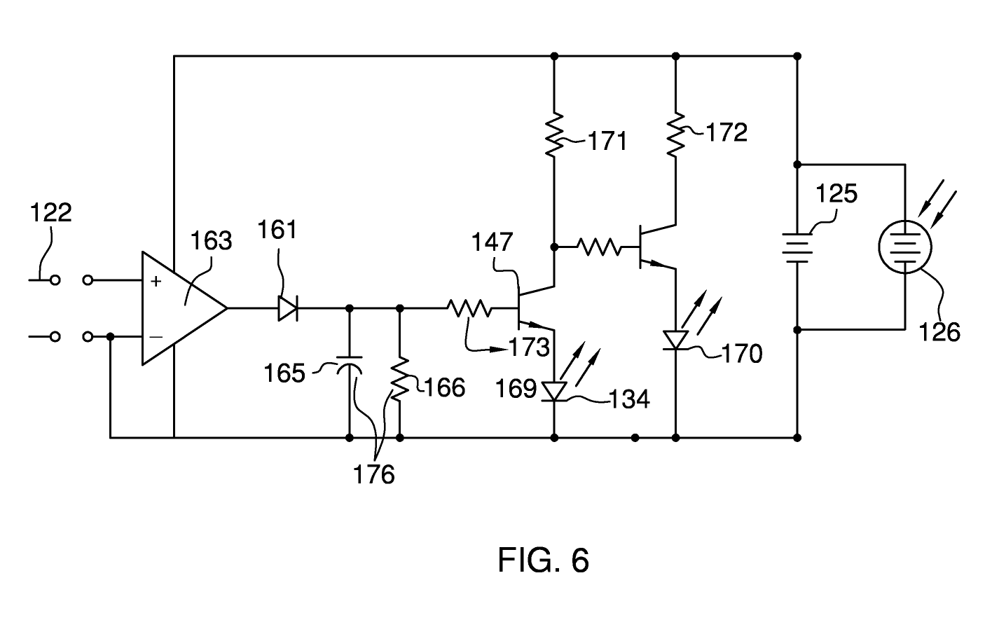

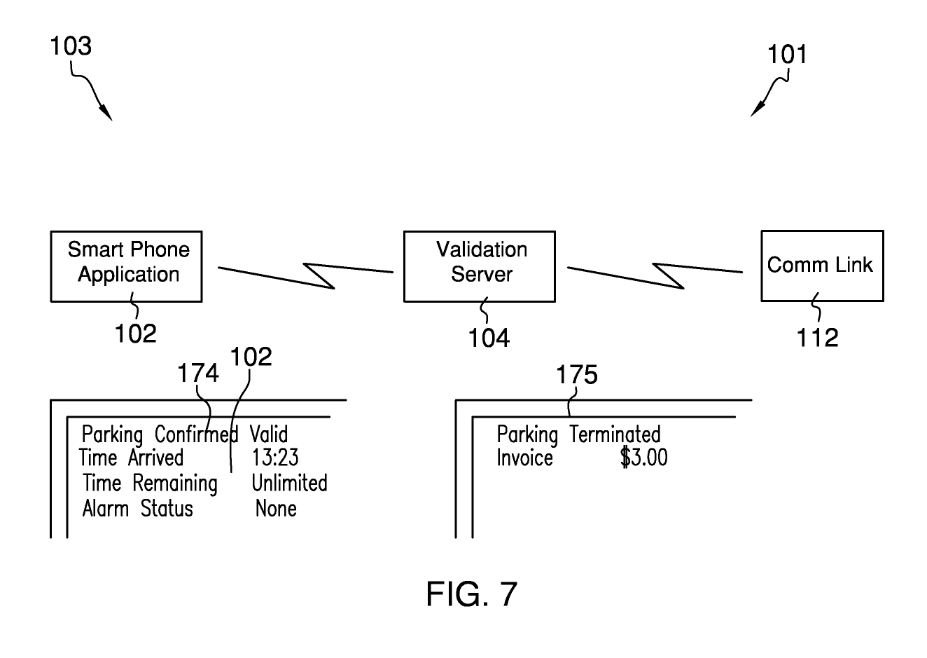

Detailed reference will now be made to a first potential embodiment of the disclosure, which is illustrated in FIGS. 1 through 8. The parking meter payment system 100 (hereinafter invention) comprises a transponder 101, a meter module 103, and a smart phone application 102. The purpose of the meter module 103 is to monitor automobiles 131 parked in the one or more parking space 132 assigned to the parking meter 133 and to collect payment for the parking services provided by the parking space 132. The purpose of the transponder 101 is to: 1) respond to a first interrogation 161 from the meter module 103 with an identification code 141 assigned to the transponder 101, and, 2) upon receipt of a second interrogation 162 from the meter module 103 adjust a visual display to initiate a valid parking indication 134 showing that the automobile 131 is parked legally. The purpose of the smart phone application 102 is to monitor the activity between the meter module 103 and the transponder 101.

It is explicitly acknowledged that the radio frequency identification technology used by the meter module 103 can be used to monitor multiple parking spaces 132. However, the specification and claims of this disclosure will hereinafter implicitly assume that one meter module 103 will be used to monitor one parking space 132. This is done for the purposes of simplicity and clarity of exposition of the disclosure and is not intended to limit the scope of the appended claims. Those skilled in the art will recognize that the disclosure can be readily modified to accommodate multiple transponders 101 located in multiple parking spaces 132 with a minimum of modification and experimentation.

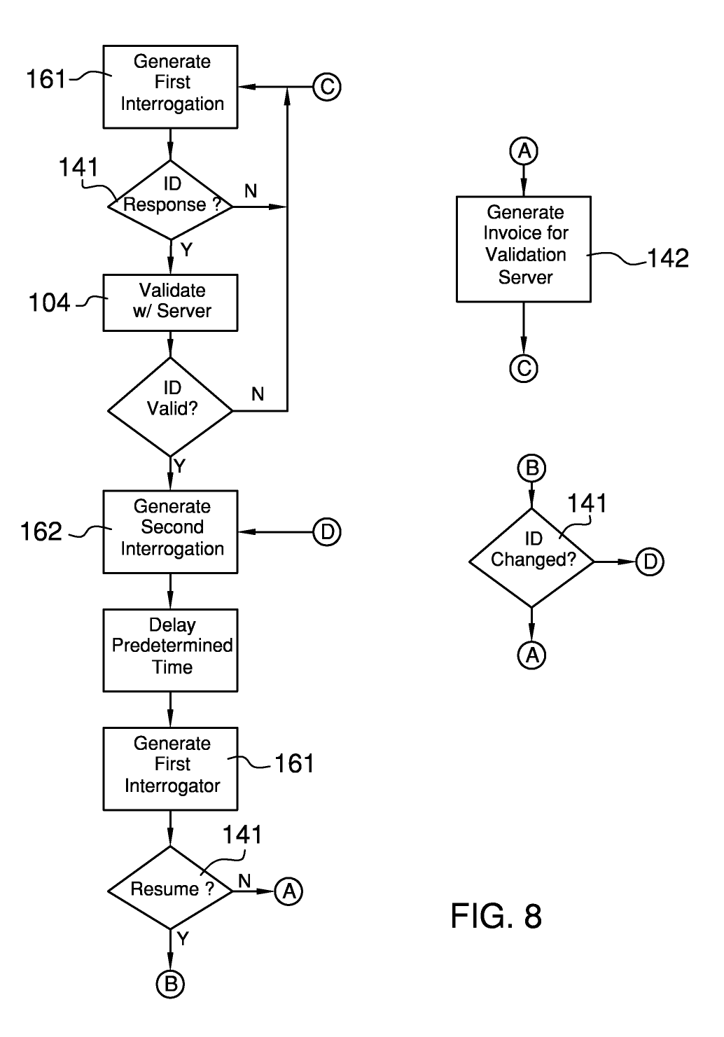

As shown in FIG. 8, the general mode of operation of the invention 100 is as follows. The meter module 103 transmits a first interrogation 161 signal at regular intervals to search for a transponder 101 located within the assigned parking space 132. When a transponder 101 is located with the assigned parking space 132, the transponder 101 responds to the first interrogation 161 with the identification code 141 assigned to the transponder 101. The meter module 103 takes the identification code 141 and forwards the identification code 141 to a validation server 104. The validation server 104 validates the identification code 141 and, if valid, sends the meter module 103 a message confirming the validity of the identification code 141. Upon confirmation of the validity of the identification code 141, the meter module 103 transmits a second interrogation 162 to the transponder 101. The second interrogation 162 initiates a logic circuit 123 within the transponder 101 that causes the transponder 101 to display a visible valid parking indication 134 indicating that the automobile 131 is legally parked in the parking space 132. The meter module 103 goes into a loop that continuously transmits the first interrogation 161 signal and, upon receipt of the identification code 141 from the transponder 101, retransmitting the second interrogation 162 until the meter module 103 no longer receives the identification code 141 from the transponder 101. When the meter module no longer receives the identification code 141 this is used as a signal that the transponder 101 is no longer located in the parking space 132. At this point, the meter module 103 generates an invoice 142 for parking services rendered and transmits the invoice 142 to the validation server 104 for payment.

Upon validation of an identification code 141, the validation server 104 sends a fourteenth message 174 to a cellular telephone number assigned to the transponder 101. The fourteenth message 174, which is displayed using a smart phone application 102, confirms that the transponder 101 has been validated. Upon receipt of an invoice 142, the validation server 104 sends a fifteenth message 175 to the cellular telephone number assigned to the transponder 101 informing the smart phone application 102 that the invoice 142 was received and the amount of the invoice 142.

The meter module 103 is a device that is attached to the parking meter 133. In order to operate, the meter module 103 needs to be connected to an externally provided source of power and needs externally provided network access. The meter module 103 further comprises a first interrogator 161, a second interrogator 162, a logic module 111, and a communication module 112. The purpose of the logic module 111 is to manage the operation and communication of the meter module 103. At regular intervals the logic module 111 initiates the first interrogator 161 to transmit a first interrogation 161 signal and to receive the return signal from a transponder 101 that contains the identification code 141. When a new identification code 141 is received, the logic module 111 forwards the identification code 141 to the communication module 112 which transmits the identification code 141 to the validation server 104. Assuming that the validation server 104 authenticates the identification code 141, the logic module 111 initiates the operation of the second interrogator 162 to transmit the second interrogation 162 signal. When the transponder 101 receives the second interrogation 162 signal, a circuit is activated with causes the transponder 101 to display a valid parking indication 134 that the automobile 131 is legally parked.

Once the parking arrangement has been initiated, the logic module 111 initiates the first interrogator 161 at regular intervals to receive the identification code 141 from the transponder 101, thereby confirming that the automobile 131 is still parked there. If the identification code 141 has not changed since the prior first interrogation 161, the logic module 111 initiates the second interrogator 162 to send the second interrogation 162 signal to the transponder 101 to refresh and maintain the valid parking indication 134. If the transponder 101 fails to transmit a response, or if a transponder 101 sends a different identification code 141 (indicating that the prior automobile 131 has left the parking space 132), the logic module 111 generates an invoice 142 for the parking services rendered that is sent to the validation server 104. The meter module 103 then returns to the initial protocol of initiating regular first interrogation 161 transmittals.

Design techniques using logic modules 111 and communication modules 112 are commercially available and well known in the art. The first interrogator 161 is a commercially available RFID reader module that operates in the 860 MHz to 960 MHz range. The second interrogator 161 is a commercially available RFID reader module that operates in the 433 MHz range. Methods to incorporate integrate, manage and operate the first interrogator and the second interrogator 162 with the logic module 111 are known in the art.

The transponder 101 is a self-contained device that, upon receiving the first interrogation 161 signal, identifies the transponder 101 to the meter module 103 and, after receiving the second interrogation 161 signal, initiates a circuit that displays a valid parking indication 134. The transponder 101 further comprises an identifier antenna 121, a validation antenna 122, a logic circuit 123, a visible display 124, a battery 125 and a solar panel 126. The identifier antenna 121 is an RFID tracking tag that is tuned to the frequency of the first interrogator 161. When challenged by the first interrogator 161, the identifier antenna 121 returns the assigned identification of the transponder 101. The validation antenna 122 is an RFID tracking tag that is tuned to the frequency of the second interrogator 162. The validation antenna 122 is modified to receive the challenge from the second interrogator 162 but instead of reflecting the energy received by the second interrogator 162, the energy is diverted to the logic circuit 123, which uses the energy to initiate a sixteenth RC timing circuit 176.

The sixteenth RC timing circuit 176 is designed to activate and maintain the valid parking indication 134 for a predetermined period of time. The logic circuit 123 comprises a third operational amplifier 163, a fourth diode 164, a fifth capacitor 165, a sixth resistor 166, a seventh transistor 167, an eighth transistor 168, a ninth light emitting diode 169, a tenth light emitting diode 170, a eleventh resistor 171, a twelfth resistor 172, a thirteenth resistor 173 which are powered by a solar panel 126 that is used to charge an internal battery 125. The sixteenth RC timing circuit comprises the fifth capacitor 165 and the sixth resistor 166. To prevent electronic cross talk, the frequency of the first interrogator 161 and the second interrogator 162 will be different. A frequency of 960 MHz for the first interrogator 161 and a frequency of 433 MHz for the second interrogator 162 is preferred.

The logic circuit 123 is assembled as follows. The components in the logic circuit 123 are powered by a solar panel 126 that is backed up by a battery 125.

The output from the validation antenna 122 is fed into the inputs of a third operational amplifier 143. The positive components of the input from the from the validation antenna 122 pass through the fourth diode 144 thereby providing only positive voltages with which to power the fifth capacitor 165. Once the fifth capacitor 165 is charged, a positive voltage is fed into the base of the seventh transistor 167, which closes the circuit and powers the ninth light emitting diode 169. The ninth light emitting diode 169 is the visible display 124 that acts as the valid parking indication 134. The ninth light emitting diode 169 will only be visible for a short period as the sixth resistor 166 will discharge the fifth capacitor 165.

Once the fifth capacitor 165 is discharged, the seventh transistor 167 closes off the current flow, or effectively turns off, the ninth light emitting diode 169. Instead, current flows through the eleventh resistor 171 to the base of the eighth transistor 148 illuminating the tenth light emitting diode 170. The tenth light emitting diode 170 is a visible signal that arrangements for approved parking have not been established. Once the second interrogator 162 re-challenges the validation antenna 122, the valid parking indication 134 will again be turned on. The purpose of the twelfth resistor 172 and the thirteenth resistor 173 is to limit current flow through the circuit.

The validation server 104 is a third party database that organizes the identification code 141 for all established accounts. The functions of the validation server 104 include: 1) validating the identification code 141 for parking purposes; 2) maintaining an escrow account within which funds are maintained and out of which the appropriate fees are paid for parking services rendered; and, 3) communicating with the designated smart phone application 102 at a cellular telephone number associated with the transponder 101. The communications described in 3) above can include, but are not limited to, communications regarding initiation of parking, termination of parking, charges incurred during parking, and time left alarms when parking in areas with limited time parking. Communication from the smart phone application 102 to the validation server 104 include, but are not limited to, communications authorizing the transfer of money to the escrow account. The communications describe above can be transmitted through a specially designed smart phone application 102 or an existing smart phone application 102 such as existing SMS (text messaging) services.

The following definitions were used in this disclosure:

Logic Module: As used in this disclosure, a logic module is a programmable device that accepts digital and analog inputs, processes the digital and analog inputs according to previously stored instruction and to provide the results of these instructions as digital or analog outputs. Processor, microprocessors, and microcontrollers are synonyms.

RFID: As used in this disclosure, RFID refers to Radio Frequency Identification technology. RFID is a wireless technology that uses electromagnetic field to identify and retrieve data from tracking tags that are placed on an object.

RFID Interrogator: As used in this disclosure, an RFID interrogator is a device that transmits a radio signal at frequency designed to activate RFID tracking tags that are tuned to operate at that frequency.

RFID Tracking Tag: As used in this disclosure, an RFID tracking tag is a reflective antenna that receives a radio signal from an RFID Interrogator and uses the energy received from the RFID interrogator signal to reflect a modified signal back to the RFID interrogator. The modified signal generally contains identification information about the RFID tag. The RFID interrogator receives and records these reflected signals. RFID tags are generally tuned to respond to a specific frequency. In this disclosure, though the RFID tags are mounted next to active components, the RFID tags themselves are passive, or unpowered, tags.

With respect to the above description, it is to be realized that the optimum dimensional relationship for the various components of the invention described above and in FIGS. 1 through 8, include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A parking meter payment system comprising:
a transponder, a meter module, and a validation server;
wherein parking meter payment system is adapted for use with parking meters;
wherein the parking meter payment system monitors one or more parking spots;
wherein the parking meter payment system initiates a first interrogation searching for a parked automobile equipped with a transponder;
wherein the transponder responds to the first interrogation with an identification code;
wherein the meter module validates the identification code using a validation server;
wherein the meter module initiates a second interrogation;
wherein upon receipt the second interrogation initiates a logic circuit within the transponder that causes the transponder to display a visible valid parking indication;
wherein the meter module continuously transmits the first interrogation signal and, upon receipt of the identification code from the transponder, transmits the second interrogation;
wherein when the meter module either no longer receives the identification code from the transponder or receives a different identification code from a transponder, the meter module generates an invoice for parking services rendered and transmits the invoice to the validation server for payment.

2. The parking meter payment system according to claim 1 further comprising
a smart phone application;
wherein upon validation of an identification code by the validation server, the validation server sends a fourteenth message to a cellular telephone number assigned to the transponder generating the identification code that the transponder has been validated
wherein upon receipt of an invoice, the validation server sends a fifteenth message to the cellular telephone number assigned to the transponder generating the identification code informing the smart phone application that the invoice has been received and the amount of the invoice.

3. The parking meter payment system according to claim 2 wherein the meter module further comprises a first interrogator, a second interrogator, a logic module, and a communication module.

4. The parking meter payment system according to claim 3 wherein the logic module manages the operation and communication of the meter module.

5. The parking meter payment system according to claim 4 wherein the communication module transmits messages to and receives messages from the validation server.

6. The parking meter payment system according to claim 5 wherein the first interrogator to transmits the first interrogation signal and to receives the return signal from a transponder that contains the identification code.

7. The parking meter payment system according to claim 6 wherein the second interrogator transmits the second interrogation signal.

8. The parking meter payment system according to claim 7 wherein the transponder further comprises an identifier antenna, a validation antenna, a logic circuit, a visible display, a battery and a solar panel.

9. The parking meter payment system according to claim 8 wherein the identifier antenna is an RFID tracking tag that is tuned to the frequency of the first interrogator.

10. The parking meter payment system according to claim 9 wherein the validation antenna is an RFID tracking tag that is tuned to the frequency of the second interrogator.

11. The parking meter payment system according to claim 10 wherein the validation antenna is modified to divert the energy received from the second interrogation to the logic circuit.

12. The parking meter payment system according to claim 11 wherein the logic circuit comprises
a third operational amplifier, a fourth diode, a fifth capacitor, a sixth resistor, a seventh transistor, an eighth transistor, a ninth light emitting diode, a tenth light emitting diode, a eleventh resistor, a twelfth resistor, a thirteenth resistor, a solar panel, and a battery;
wherein the fifth capacitor and sixth resistor combine to form the sixteenth RC timing circuit.

13. The parking meter payment system according to claim 12 wherein the sixteenth RC timing circuit is designed to activate and maintain the valid parking indication for a predetermined period of time.

14. The parking meter payment system according to claim 13 wherein
the output from the validation antenna is fed into the inputs of the third operational amplifier;
wherein the output of the third operational amplifier pass through the fourth diode;
wherein the fourth diode charges the sixteenth RC timing circuit;
wherein the sixteenth RC timing circuit closes a seventh transistor to illuminate the ninth light emitting diode.

15. The parking meter payment system according to claim 14 wherein
the validation server is a computer that operates a database that organizes the identification code for all established accounts;
wherein the validation server validates the identification code for parking purposes, maintains an escrow account within which funds are maintained and out of which the appropriate fees are paid for parking services rendered, and communicates with the designated smart phone application at a cellular telephone number associated with the transponder.

16. The parking meter payment system according to claim 1 wherein the transponder further comprises an identifier antenna, a validation antenna, a logic circuit, a visible display, a battery and a solar panel.

17. The parking meter payment system according to claim 16 wherein the identifier antenna is an RFID tracking tag; wherein the validation antenna is an RFID tracking tag.

18. The parking meter payment system according to claim 17 wherein the validation antenna is modified to divert the energy received from the second interrogation to the logic circuit.

19. The parking meter payment system according to claim 18 wherein the logic circuit comprises a third operational amplifier, a fourth diode, a fifth capacitor, a sixth resistor, a seventh transistor, an eighth transistor, a ninth light emitting diode, a tenth light emitting diode, a eleventh resistor, a twelfth resistor, a thirteenth resistor, a solar panel, and a battery.
